(19) United States
(12) Patent Application Publication
(10) Pub. No.: US 2026/0166517 A1
(43) Pub. Date: Jun. 18, 2026

(54) MOF-MODIFIED RICE HUSK BIOCHAR COMPOSITE MATERIAL, ITS PREPARATION METHOD, AND APPLICATIONS

(71) Applicant: Institute of Agricultural Resources and Regional Planning, CAAS, Beijing (CN)

(72) Inventors: Qianru Zhang, Beijing (CN); Qilan Huang, Beijing (CN); Shuwen Zhao, Beijing (CN)

(21) Appl. No.: 19/396,031

(22) Filed: Nov. 20, 2025

(30) Foreign Application Priority Data
Dec. 14, 2024 (CN) 202411919947.2

(51) Int. Cl. B01J 20/22; B01J 20/30; B01J 20/32; C02F 1/28; C02F 101/10

(52) U.S. Cl. CPC B01J 20/226; B01J 20/3078; B01J 20/3204; B01J 20/3214; B01J 20/3265; C02F 1/288; C02F 1/283; C02F 1/285; C02F 2101/10

(57) ABSTRACT

This invention discloses a MOF-modified rice husk biochar composite for adsorbing rare earth ions. The preparation method includes: pyrolyzing dried rice husk powder to produce biochar (BC); mixing the BC, FeCl₃, and water to form a first solution; mixing phthalic acid, NaOH, and water to form a second solution; combining both solutions; and heating the mixture, followed by separation, washing, and drying. Using BC as a carrier reduces MOF solubility, prevents secondary pollution, and improves recyclability. The composite also exhibits increased specific surface area and porosity, providing more active sites for highly efficient rare earth ion adsorption. This MOF-biochar material is non-toxic, environmentally friendly, and chemically stable. Its preparation is simple and operable, showing promising application potential.

### CROSS-REFERENCE TO RELATED APPLICATION

This application claims priority of Chinese Patent Application No. 202411919947.2, filed on Dec. 24, 2024, the entire contents of which are incorporated herein by reference.

### TECHNICAL FIELD

This invention pertains to the field of water treatment in environmental protection, specifically a selective adsorbent for the rare earth element lanthanum, designed to treat rare earth pollution in water bodies.

### BACKGROUND

Rare earth ions, owing to their excellent physicochemical properties, hold significant strategic importance for nations pursuing high-precision industrial development, earning them the moniker “industrial vitamins.” Rare earth mining generates substantial volumes of low-concentration wastewater containing rare earth elements (0.8-130 mg L⁻¹), which subsequently form rare-earth waste. Given the scarcity and non-renewable nature of rare earth resources, coupled with the potential non-biodegradability and toxicity of rare earth ions, their recovery and reuse are of significant economic and environmental importance.

Various methods have been developed for rare earth recovery, including chemical precipitation, extraction, ion exchange, and adsorption. Among these recovery techniques, adsorption has garnered significant attention because of its environmental friendliness, low cost, high selectivity, and effectiveness at low concentrations. Although numerous adsorbents have been developed for recovering rare earth ions from aqueous solutions, such as clay minerals, imidazolium zeolite frameworks, cellulose nanocomposites, and graphene oxide-based nanocomposites, the limited adsorption capacity of these conventional materials restricts their widespread application in rare earth ion recovery.

As one of the most abundant and useful lanthanide elements, La has extensive applications in the production of precision optical glass and ceramics, agriculture, steel processing, and catalysis. However, due to the genotoxicity of La (III) to human peripheral blood lymphocytes, wastewater containing La discharged from industrial processes can pollute the environment and endanger human health. Therefore, there is an urgent need to develop an adsorbent capable of efficiently adsorbing La (III).

Biochar (BC) is of immense practical value for removing environmental pollutants, such as heavy metals and organic contaminants. Simultaneously, biochar offers environmental benefits, cost-effectiveness, and strong adaptability, transforming agricultural and anthropogenic wastes, such as rice husks, straw, and manure, into valuable resources. The production of biochar also contributes to mitigating the greenhouse effect, which aligns with the requirements of the dual-carbon strategy. The adsorption efficacy of biochar primarily depends on its specific surface area and the presence of external functional groups. Modification strategies significantly increase the number of active sites in raw biochar, enhance its specific surface area, and boost its adsorption capacity.

Metal-organic frameworks (MOFs) are novel crystalline porous materials formed by metal nodes and organic ligands connected through coordination bonds. They offer advantages such as a high specific surface area, porosity, and rich functional groups, making them highly suitable for removing various pollutants from water compared to traditional adsorbents. The defining features of MOFs are their structural versatility and designability, allowing tailored structures for specific applications and selective binding of desired elements even in the presence of different interferences.

### SUMMARY

The MOF of this invention utilizes trivalent iron as the metal ion. Compared to divalent metals such as Zn and Cu, trivalent Fe can achieve a higher oxidation state, thereby participating in stronger metal-ligand interactions and forming MOFs with superior hydrothermal stability. The chemical and hydrolysis stability of Fe-MOFs makes them highly suitable for adsorbing and removing pollutants from aqueous media. Furthermore, the presence of high-valent Fe (III) and carboxylate residues generates numerous active sites capable of adsorbing contaminants from the environment. While Lewis acidic rare earth ions readily form complexes with oxygen-containing functional groups and adsorb onto MOFs, the fine particle size and non-negligible water solubility of MOF powders limit their applicability, particularly in continuous-flow systems. MOF-modified biochar composites not only retain the respective advantages of BC and MOFs, such as porosity, high specific surface area, and active sites, but also achieve specific adsorption of La³⁺ through electrostatic attraction between BC's large conjugated aromatic rings and La³⁺, coupled with ligand exchange between MOF's oxygen-containing functional groups and La³⁺. This specific adsorption capability endows MOF-modified biochar composites with potential application value in treating wastewater or exhaust gas containing La³⁺.

To achieve the aforementioned purposes, the invention prepares an adsorbent for efficiently removing La (III) from water, which is characterized by the following specific steps:

The dried rice husk powder was placed in a high-temperature atmosphere furnace and heated to obtain rice husk biochar. The rice husk biochar, FeCl₃, and water were mixed to form the first solution. Phthalic acid, NaOH, and water were mixed to form the second solution. The first and second solutions were combined and the mixture was heated. The solid and liquid phases were separated, the solid was washed, and dried to obtain the MOF-modified rice husk biochar composite material.

The mixing and agitation conditions were as follows: temperature of 10-40° C., time of 12-72 hours, and rotation speed of 150-250 rpm; The amount of the MOF-modified rice husk biochar composite material added was 0.1-0.4 g/L; and the concentration range of La³⁺ in the rare earth ion solution was 1-200 mg/L.

The preparation method of MOF-modified rice husk biochar composite material was prepared as follows:
(1) Dried rice husk powder was placed in a high-temperature atmosphere furnace and heated to obtain rice husk biochar.
(2) Rice husk biochar, FeCl₃, and water were mixed to obtain the first solution, and phthalic acid, NaOH, and water were mixed to obtain the second solution.
(3) The first and second solutions were mixed thoroughly. The resulting mixture was heated, the solids were separated from the liquids, washed, and dried to obtain the MOF-modified rice husk biochar composite material.

The heating conditions in step (1) were as follows: raise the temperature to 300-700° C. at a heating rate of 1-20° C./min, and maintained for 0.5-4 h.

In step (2), the mass ratio of rice husk biochar, FeCl₃, and water is 1:10-30:500;

The mass ratio of phthalic acid, NaOH, and water is 1-12:1:10-50.

In step (3), the mass ratio of the first solution to the second solution was 1-50:1; the heating conditions were as follows: placement in an electric hot-air drying oven at 60-150° C. for 12-24 hours; the washing conditions were as follows: washing three times with deionized water and ethanol. The drying conditions were as follows: drying in a vacuum oven at 60-80° C. for 12 h.

The rare earth ion was La³⁺.

The rare earth ion recovery method is characterized by the following:

Mixing and agitating the MOF-modified rice husk biochar composite material described in claim 5 with a rare earth ion solution, followed by solid-liquid separation.

The mixing and agitation conditions were as follows: temperature of 10-40° C., time of 12-72 hours, and rotation speed of 150-250 rpm.

The amount of the MOF-modified rice husk biochar composite material added was 0.1-0.4 g/L.

The concentration range of La³⁺ in the rare earth ion solution was 1-200 mg/L.

The invention has the following beneficial effects.
(1) This invention utilizes BC as a carrier to reduce the solubility of MOF, prevent secondary pollution, enhance recyclability, increase the pore volume of the composite material, and increase the number of active sites. Ultimately, this achieves highly efficient adsorption of rare earth ions by the composite material.
(2) The MOF-modified rice husk biochar composite material provided by this invention is a harmless and environmentally friendly material. It offers advantages such as non-toxicity and excellent chemical stability. Additionally, its preparation method is simple and highly operable, presenting promising prospects for application.

### BRIEF DESCRIPTION OF THE FIGURES

To explain the technical scheme of the embodiments of the present invention more clearly, the attached drawings required for the description of the embodiments are briefly introduced.

FIG. 1A shows the optimized structure of the MOF-modified rice husk biochar composite material obtained through DFT simulation calculations.

FIG. 1B shows the adsorption model of lanthanum ions by the MOF-modified rice husk biochar composite material through ligand exchange.

FIG. 1C shows the adsorption model of lanthanum ions by the MOF-modified rice husk biochar composite material through π-π conjugation.

FIG. 2 shows the morphology of the MOF-modified rice husk biochar composite material.

FIG. 3 shows the XRD pattern of the MOF-modified rice husk biochar composite material.

FIG. 4 shows the nitrogen adsorption-desorption isotherm of the MOF-modified rice husk biochar composite material.

FIG. 5 shows the thermogravimetric analysis of the MOF-modified rice husk biochar composite material.

FIG. 6 shows the FTIR spectrum of the MOF-modified rice husk biochar composite material.

FIG. 7A shows the Fe 2p spectrum of the MOF-modified rice husk biochar composite material.

FIG. 7B shows the O 1s spectrum of the MOF-modified rice husk biochar composite material.

FIG. 7C shows the C 1s spectrum of the MOF-modified rice husk biochar composite material.

FIG. 8 shows the adsorption isotherms of rare earth ions for BC, MOF, and MOF-modified rice husk biochar composites after 24 h of oscillation.

FIG. 9 shows the adsorption kinetics of rare earth ions by the MOF-modified rice husk biochar composite material.

FIG. 10 shows the selectivity of the MOF-modified rice husk biochar composites toward rare earth ions.

FIG. 11 shows the reusability of the MOF-modified rice husk biochar composite materials.

### DESCRIPTION OF THE INVENTION

The present invention is further described with specific examples below; however, the scope of protection of the present invention is not limited to the examples. If a skilled person in this field makes some immaterial improvements and adjustments to the present invention according to the above-mentioned contents, it still belongs to the scope of protection of the present invention.

### Embodiment 1

Performance testing was conducted on the MOF-modified rice husk biochar composite material, as described in Example 1.

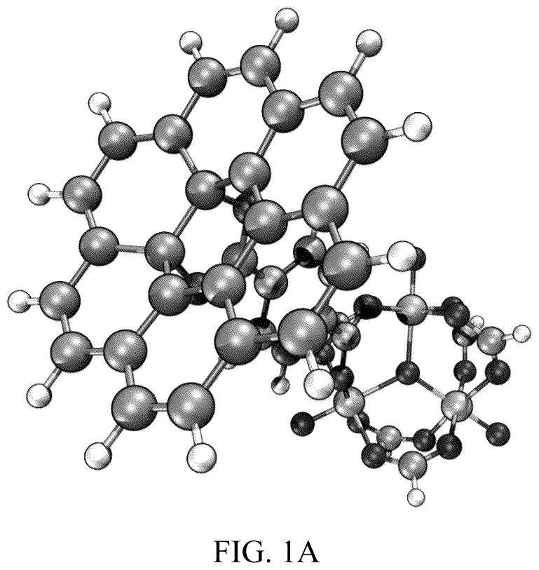

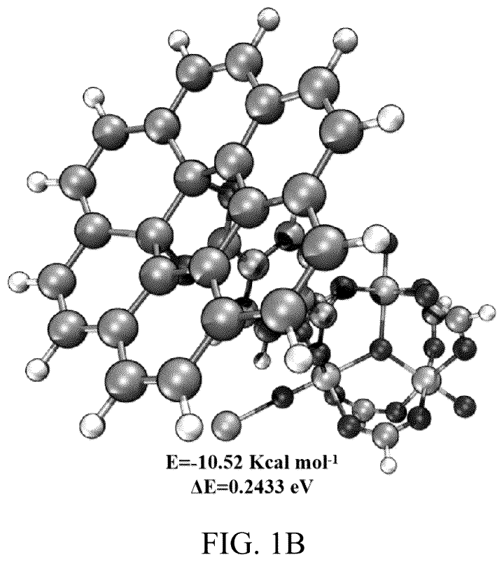

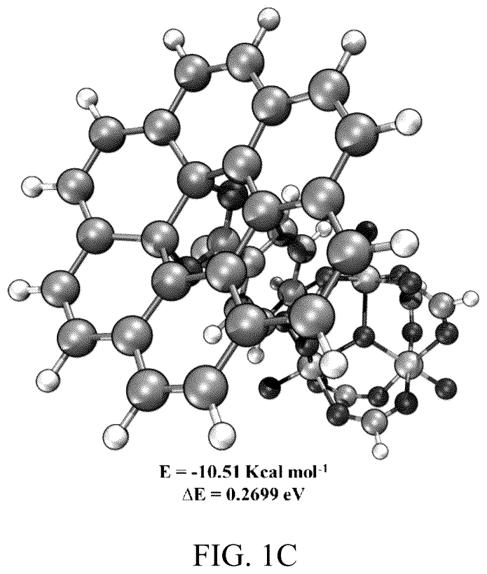

FIG. 1A-C shows the optimized structure and adsorption model for La³⁺ calculated via DFT simulations (using Device Studio and BDF software modules) of the MOF-modified rice husk biochar composite. During the growth and preparation of the MOF-modified rice husk biochar composite (denoted as BC@MIL−88b), organic ligands and metal ions within the MOF selectively bind to the minimal structural units. As the MOF expands, minimal structural units form ionic associations with the carbon framework surrounding the oxygen functional groups of BC. The remaining ligands and metal ions bind near the attachment points and self-assemble to form BC@MIL-88b secondary structural units. During this process, certain oxygen-containing functional groups of BC (including carboxyl, carbonyl, and aldehyde groups) inhibit the expansion of the MOF. The combined SEM analysis revealed that the BC surface was covered by rod-like MIL-88b structures. We employed a pure graphene structure to simulate the surface architecture of aromatized bio-derived BC, simplifying the computational modeling. This strategy has been successfully applied in numerous studies, with positive outcomes. Considering the large cell structure of Fe-MOF, a cluster model featuring Fe nodes and surface-bound carboxylate monomer ligands was selected to enhance the computational efficiency. The optimal adsorption arrangement of BC@MIL-88b is shown in FIG. 1A. This structure exhibited a significant negative adsorption energy, indicating the spontaneous binding of La to these sites. The corresponding interactions primarily arise from La—O bond formation (FIG. 1B) and π-π conjugation between La³⁺ and benzene rings (FIG. 1C). As shown in FIG. 1B-C, the La—O bond interaction is prominent and contributes to enhanced stability. The interaction energies for La³⁺ adsorption on BC@MIL-88b were −10.52 and −10.51 kcal·mol⁻¹, respectively. This demonstrates that the MOF significantly influences the adsorption properties of the BC surface.

### Embodiment 2

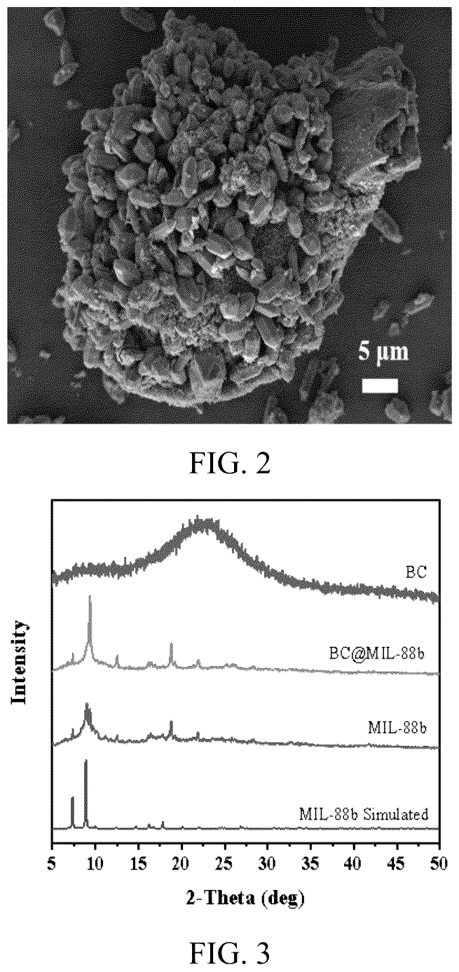

FIG. 2 shows the scanning electron microscopy (SEM) morphology of the MOF-modified rice husk biochar composite material. The biochar exhibited an interconnected layered porous structure with a smooth surface and no visible material adhesion. The MOF (designated as MIL-88b, MIL-88b was prepared by following steps (2) and (3) of Example 1 except without adding BC) consisted of nanorods approximately 1 μm in length and 200 nm in width. BC@MIL-88b retained the layered porous structure of BC; however, some MIL-88b particles blocked the pores, potentially reducing the number of active sites. Testing revealed that the pore volume of the MOF-modified rice husk biochar composite from Example 1 was 0.147 cm³ g⁻¹.

### Embodiment 3

FIG. 3 shows the X-ray diffraction (XRD) patterns of the MOF-modified rice husk biochar composites, along with the diffraction peaks of BC, MIL-88b, and standard MIL-88b samples.

The XRD pattern of BC@MIL-88b exhibits prominent, sharp peaks, indicating high crystallinity. The main peaks in the MIL-88b pattern matched those in the corresponding crystal information file (2088535), confirming the successful synthesis of this MOF. The peaks of BC@MIL-88b closely resembled those of MIL-88b but exhibited lower diffraction angles. This discrepancy may result from MOF diffusion onto the BC surface or from defects/impurities within BC, creating larger interstices within the MOF crystal structure.

### Embodiment 4

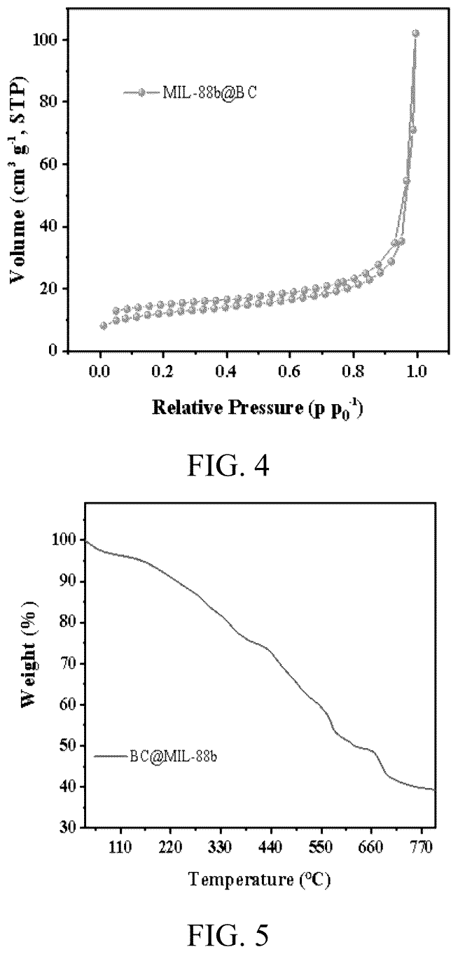

FIG. 4 shows the nitrogen adsorption-desorption isotherm curve of the MOF-modified rice husk biochar composite material. Theoretically, the decoration of the MOF on the BC surface should increase the specific surface area and pore volume of the BC. However, the introduction of MOF particles may also obstruct internal voids, thereby reducing the specific surface area. The average pore diameter of BC@MIL-88b was 10.05 nm, indicating that it was predominantly mesoporous.

### Embodiment 5

FIG. 5 shows the thermogravimetric analysis (TGA) curve of the MOF-modified rice husk biochar composite material. The thermal stability of the composite adsorbent was higher than that of its constituent components. The TGA curve of BC@MIL-88b exhibited three weight-loss stages. The first weight loss occurs between 30 and 110° C., which is attributed to the evaporation of physically adsorbed surface moisture. The second weight loss (27.89%) occurred between 110 and 430° C., reflecting the evaporation of solvent molecules from the internal pores. The third weight loss (31.74-34.35%) occurred between 430 and 700° C., which was attributed to ligand carbonization and MOF structural collapse.

### Embodiment 6

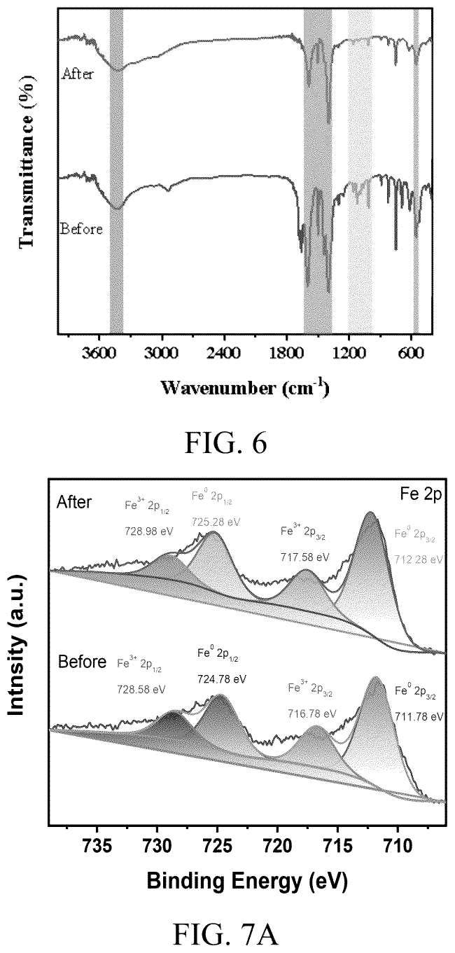

FIG. 6 shows the FTIR spectra of the MOF-modified rice husk biochar composite before and after rare earth ion adsorption. After 24 h of shaking at 250 rpm at room temperature in a 100 mg L⁻¹ La³⁺ solution, the MOF-modified rice husk biochar composite underwent solid-liquid separation. A distinct O-H peak was observed at 3447.08 cm⁻¹, while carboxyl C—O peaks appeared at 1660.57 cm⁻¹ (asymmetric stretching) and 1389.50 cm⁻¹ (symmetric stretching). Peaks at 1500-1600 cm⁻¹ are attributed to the stretching vibrations of the benzene ring skeleton, while peaks at 1253.74 and 1157.03 cm⁻¹ correspond to C—O—C molecular vibrations. The peak at 552.01 cm⁻¹ disappeared upon adsorption and was replaced by an Fe—O peak at 553.29 cm⁻¹. These data indicate that during adsorption, La³⁺ interacts with the metal ions to form Fe—O—La covalent bonds. The peak at 3392.27 cm⁻¹ weakened after adsorption, suggesting that La³⁺ was adsorbed via hydroxyl substitution rather than direct iron binding. The shift in the peak at 1500-1600 cm⁻¹ indicates the involvement of the benzene ring structure in La³⁺ adsorption. Therefore, we conclude that during adsorption, the hydroxyl group is replaced by La³⁺ via ligand exchange, which forms Fe—O—La bonds. This conclusion is consistent with the results of the adsorption kinetic experiments.

### Embodiment 7

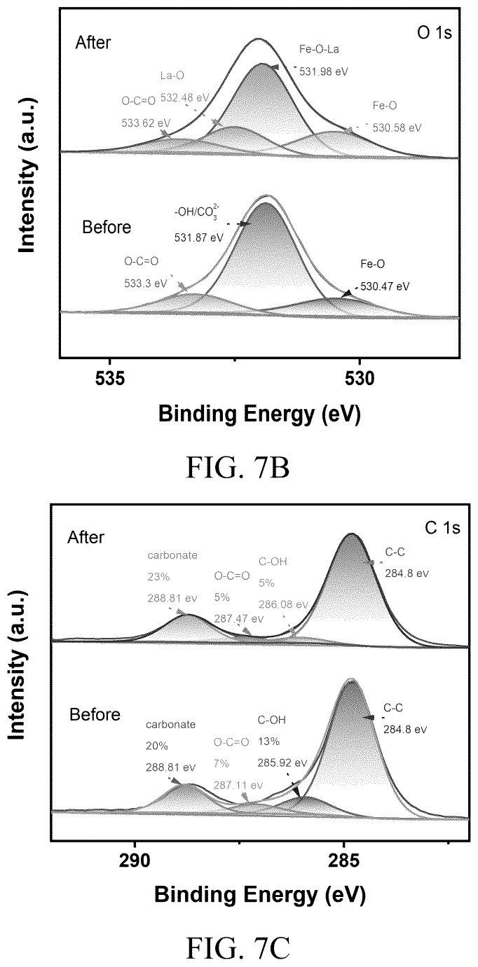

FIG. 7A-C shows the XPS spectra of the MOF-modified rice husk biochar composite before and after the adsorption process. The Fe 2p spectrum (FIG. 7A) exhibited characteristic Fe 2p_{1/2} peaks at 728.58 and 724.78 eV and characteristic Fe 2p_{3/2} peaks at 716.78 and 711.78 eV. After adsorption, these peaks red-shifted to 728.98, 725.28, 717.58, and 712.28 eV, indicating electron transfer in the Fe 2p valence band (possibly due to the substitution of functional groups in the adsorbate). This change altered the chemical environment around Fe, suggesting the potential formation of internal Fe—O—La complexes. The O 1s spectrum (FIG. 7B) exhibited peaks corresponding to Fe—O (530.47 eV), —OH (531.87 eV), and O—C═O (533.3 eV). After adsorption, the —OH peak disappeared and was replaced by Fe—O—La (531.98 eV) and La—O (532.48 eV) peaks. The C 1s spectrum (FIG. 7C) exhibited C—C (284.8 eV), C—OH (285.92 eV), O—C═O (287.11 eV), and carbonate (288.81 eV) peaks. After adsorption, the C—OH and O—C═O peaks shifted, and their area percentages decreased from 13% to 5% and from 7% to 5%, respectively. Thus, reactive —OH groups can be replaced by La, forming internal Fe—O—La complexes via ligand exchange and adsorbing La³⁺ ions. These results are consistent with the FTIR spectroscopy findings.

### Embodiment 8

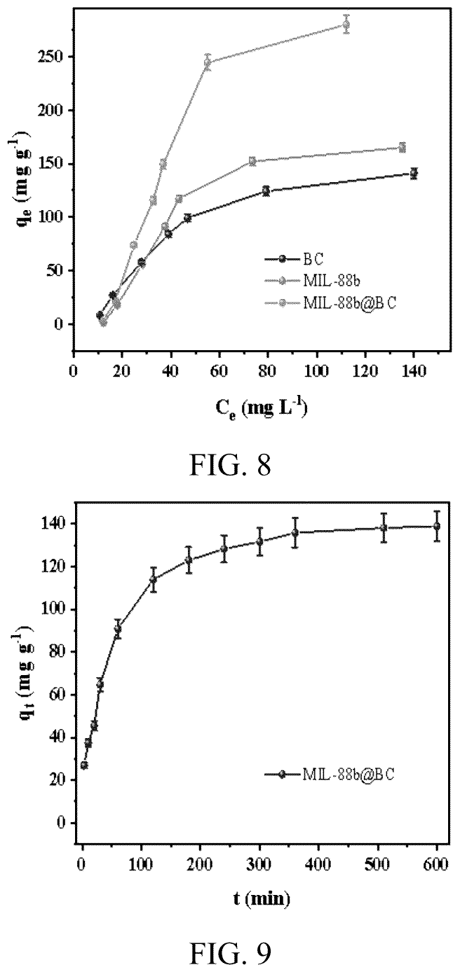

FIG. 8 shows the La³⁺ adsorption isotherm obtained under initial La³⁺ concentrations ranging from 5 to 100 mg L⁻¹ and a pH of 6.0, with stirring at 298 K and 250 rpm for 24 h. As the La³⁺concentration increased, the adsorption capacity of BC@MIL-88b for La³⁺ also increased until equilibrium was attained. The maximum adsorption capacity of La³⁺ on BC@MIL-88b reached 288.89 mg g⁻¹.

### Embodiment 9

FIG. 9 shows the effect of reaction time (3-600 min) on the adsorption capacity of La³⁺ (60 mg L⁻¹) on BC@MIL-88b at 298 K and a stirring rate of 250 rpm. The adsorption capacity increased over time, reaching adsorption equilibrium after 6 h of reaction.

### Embodiment 10

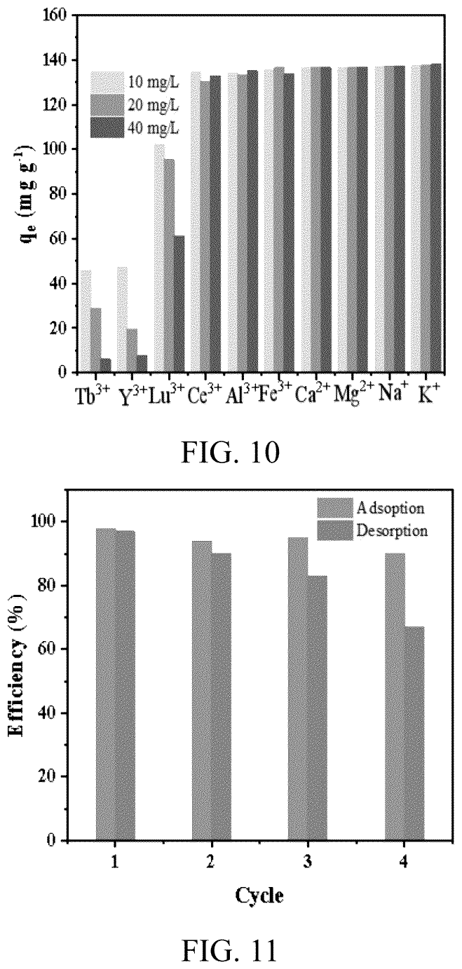

FIG. 10 shows the selectivity of BC@MIL-88b toward La³⁺ when Tb³⁺, Y³⁺, Lu³⁺, Ce³⁺, Al³⁺, Fe³⁺, Na⁺, K⁺, Ca²⁺, and Mg²⁺ were used as the interfering cations. Tests were conducted at a La³⁺concentration of 60 mg L⁻¹ and interference concentrations of 10, 20, and 40 mg L⁻¹. Ce³⁺, Al³⁺, Fe³⁺, Na⁺, K⁺, Ca²⁺, and Mg²⁺ showed no significant interference with La³⁺ adsorption. However, Tb³⁺, Y³⁺, and Lu³⁺ adversely affected La³⁺ adsorption, with interference increasing at higher concentrations. In actual water bodies, the concentrations of Tb³⁺, Y³⁺, and Lu³⁺ are far below the tested levels.

### Embodiment 11

FIG. 11 shows the recyclability of BC@MIL-88b, tested at 298 K using 0.05 M HCl as the eluent. After four cycles, the adsorption capacity of BC@MIL-88b for 5 mg L⁻¹ La³⁺ solution remained above 93%, with desorption rates exceeding 80% in all cycles prior to the final cycle.

Although the invention has been described in detail above with general descriptions and specific embodiments, some modifications or improvements can be made based on the invention, which is obvious to those skilled in the art. Therefore, all these modifications or improvements made without departing from the spirit of the invention are included in the scope of the invention.

1. A MOF-modified rice husk biochar composite material, its preparation method, and applications are characterized by the method comprises the following steps:
(1) Dried rice husk powder was placed in a high-temperature atmosphere furnace and heated to obtain rice husk biochar;
(2) Rice husk biochar, FeCl₃, and water were mixed to obtain the first solution, and phthalic acid, NaOH, and water were mixed to obtain the second solution;
(3) The first and second solutions were mixed, the resulting mixture was heated, the solids were separated from the liquids, and the solids were washed and dried to obtain the MOF-modified rice husk biochar composite material.

2. The preparation method of the MOF-modified rice husk biochar composite material according to claim 1, characterized in that in step (1), the heating conditions are: heating at a rate of 1-20° C./min to 300-700° C. and maintaining the temperature for 0.5-4 h.

3. The preparation method for the MOF-modified rice husk biochar composite material according to claim 1, characterized in that in step (2), the mass ratio of rice husk biochar, FeCl₃, and water is 1:10-30:500; the mass ratio of phthalic acid, NaOH, and water is 1-12:1:10-50.

4. The preparation method of the MOF-modified rice husk biochar composite material according to claim 1, wherein in step (3), the mass ratio of the first solution to the second solution is 1-50:1; the heating condition is: placing in an electric hot-air drying oven at 60-150° C. for 12-24 hours; the washing conditions comprise washing three times with deionized water and ethanol; and the drying conditions comprise drying for 12 h in a vacuum oven at 60-80° C.

5. A MOF-modified rice husk biochar composite material, characterized by being prepared by the method described in claim 1.

6. A MOF-modified rice husk biochar composite material, characterized by being prepared by the method described in claim 2.

7. A MOF-modified rice husk biochar composite material, characterized by being prepared by the method described in claim 3.

8. A MOF-modified rice husk biochar composite material, characterized by being prepared by the method described in claim 4.

9. The application of the MOF-modified rice husk biochar composite material according to claim 5 for rare earth ion recovery.

10. The application of the MOF-modified rice husk biochar composite material according to claim 6 for rare earth ion recovery.

11. The application of the MOF-modified rice husk biochar composite material according to claim 7 for rare earth ion recovery.

12. The application of the MOF-modified rice husk biochar composite material according to claim 8 for rare earth ion recovery.

13. The application according to claim 9, characterized in that the rare earth ion is La³⁺.

14. The application according to claim 10, characterized in that the rare earth ion is La³⁺.

15. The application according to claim 11, characterized in that the rare earth ion is La³⁺.

16. The application according to claim 12, characterized in that the rare earth ion is La³⁺.

17. A method for rare earth ion recovery, characterized in that the method comprises:
Mixing and agitating the MOF-modified rice husk biochar composite material described in claim 5 with a rare earth ion solution, followed by solid-liquid separation.

18. A method for rare earth ion recovery, characterized in that the method comprises:
Mixing and agitating the MOF-modified rice husk biochar composite material described in claim 6 with a rare earth ion solution, followed by solid-liquid separation.

19. A method for rare earth ion recovery, characterized in that the method comprises:
Mixing and agitating the MOF-modified rice husk biochar composite material described in claim 7 with a rare earth ion solution, followed by solid-liquid separation.

20. The method according to claim 17, characterized by
The mixing and agitation conditions were as follows: temperature of 10-40° C., time of 12-72 hours, and rotation speed of 150-250 rpm; The amount of the MOF-modified rice husk biochar composite material added was 0.1-0.4 g/L; and the concentration range of La³⁺ in the rare earth ion solution was 1-200 mg/L.
